(19) United States
(12) Patent Application Publication
(10) Pub. No.: US 2012/0186681 A1
(43) Pub. Date: Jul. 26, 2012

(54) METHODS AND APPARATUS FOR MANUFACTURING METAL COMPONENTS WITH CERAMIC INJECTION MOLDING CORE STRUCTURES

(76) Inventors: Donald Sun, San Gabriel, CA (US); Mark William Vilimek, Milpitas, CA (US)

(21) Appl. No.: 13/379,632

(22) PCT Filed: Jun. 25, 2010
(86) PCT No.: PCT/US10/40096

§ 371 Date: Apr. 12, 2012

Related U.S. Application Data
(60) Provisional application No. 61/269,624, filed on Jun. 26, 2009.

(51) Int. Cl. F15B 13/00

(52) U.S. Cl. 137/801

(57) ABSTRACT

Preforms for use in injection blow molding processes and such processes are described herein. The preforms can have both a body and a neck wherein the external body diameter of the preform is at most 95% of the external neck diameter. The body comprises internal and external diameters that together form a sidewall, the thickness of which can be greater than 2.0 mm. Also disclosed is a mold for the injection molding of the preform described above.

### CROSS-REFERENCE

This application claims the benefit of priority to U.S. Provisional Application No. 61/269,624 filed Jun. 26, 2009, which is incorporated by reference herein in its entirety.

### FIELD OF INVENTION

The invention relates to investment casting. More particularly, the invention relates to processes and structures formed from ceramic core patterns for lost wax investment casting that are capable of producing single body metal structures formed with single or multiple interior chambers.

### BACKGROUND

Environmental concerns around pollution and current economic development are forcing changes to the design and manufacture of water faucets that traditionally have been constructed of soft metal alloys containing lead (Pb). For more than hundred years, this traditional manufacturing process has been improved from sand casting to shell molding, even permanent mold casting. This process typically utilizes low-temperature metal alloys that require casting temperature under 1050° C. By using a resin sand core in this process, a hollow-center multi-chamber low-temperature alloy faucet body can be formed.

Most of the faucet bodies today are made of low-temperature alloys, which contain heavy elements such as lead, cadmium and arsenic that are both naturally occurring and part of lead element. Thus the composition of the alloy can be detrimental to humans. The internal water passage areas will contact water flow whenever the faucet is in use. Over the course of a normal life of the unit, it is cycled through repeated on/off cycles exposing the passages to air and then water accelerating the corrosion process, which enables heavy elements to leach off of the unit over its entire service life. The water flow thus contain trace amounts of heavy elements will bring out traces of lead, which will subsequently mixed with the water, and the long-term use of such water to wash fruits and vegetables (or cooking of food) with trace amounts of lead will be directly or indirectly consumed and absorbed into the human body. These heavy metal elements will accumulate beyond the tolerance or load of human body and organs that will eventually lead to or cause various types of known toxic metal lead poisoning that impacts the nervous systems, mental capacity, skeletal, muscular and cardiovascular systems. These conditions are particularly harmful to young children, pregnant women and older adults. If human beings drink such water for a long or extended period of time, this will be harmful to their bodies and cause damage to their brains, nervous systems, kidneys and red blood cells. In particular, if pregnant women and children drink such water, then the consequences are unthinkably miserable.

As a result of the lead content in low-temperature metal alloys, which has been proven to cause significant harm to human beings, the State of California, the Environmental Protection Agency (EPA) in of United States of America and the Restriction of Hazardous Substances (RoHS) directive in the European Union have, begun to implement recently announced series of new legislations. Under new regulations, the lead content of faucets, pipelines, taps used in kitchen and drinking water system should not exceed 0.20% and 0.25%, respectively. The purpose of these provisions is to protect human drinking water that comes in contact directly or indirectly with all water delivery devices, such as pipelines, containers, plumbing and faucets, which should not contain excessive levels of heavy metal lead element. At present, the use of low-temperature metal alloy as raw material to manufacturing the faucets, such as brass faucet body materials, are mostly used in sand casting and/or shell molding. The limitation of the lead content in such brass alloy should be lower than 4% prior to Jan. 1, 2010. However, as of Jan. 1, 2010, such lead limit for brass alloy in a plumbing fixture must be less than 0.25%, as stipulated by California's AB1953.

Stainless Steel and other high temperature alloys are the obvious replacement to low-temperature but require a different manufacturing process. Investment casting is a commonly used technique for forming high-temperature metallic components having complex geometries, such as gas turbine engine components. However due to the complexity and small size of the internal passages, construction of a water faucet main body, there are many drawbacks in using current manufacturing processes and investment casting techniques to form water faucet main bodies. These include, but are not limited to, the following: the lack of a de-molding-able support to produce hollow chambers within a wax pattern; the difficulties of homogenous slurry dipping and coating when dipping to build up the layers with adequately necessary shell strength for a subsequent process of shell sintering and pouring of melted stainless steel; and the internal shell removal from or out of a casting body. Consequently such substantial limitations in various stages of an investment casting process fail to produce a sophisticated casting body constructed with the internal complexity of one or more hollow center chambers at an industrial scale with economics that matches the low-temperature alloys. For example, U.S. Patent Publication No. 2004/0221385 describes a single chamber utility faucet by using a soluble wax core. This description generally represents the current level of investment casting available today for making stainless steel utility faucets with serious limitations in the formation process which not only limits the functionality and aesthetics of the unit, but requires expensive and complex secondary processes such as welding, multiple part assembly and other steps that may introduce oxidation, corrosion, points of failure and un-necessary manufacturing expenses.

There is a need for water fixtures that are compliant with current and future health regulatory standards and economic methods of their manufacture. A need further exists for stainless steel faucets that can be formed with a one-body construction and a hollow center with internal multi-chambers that are beyond the reach or capabilities of the aforementioned teachings and production methods currently available today.

### SUMMARY OF INVENTION

The invention provides ceramic injection molding (CIM) manufacturing processes and structures that produce end products formed with a single one-body or one-piece seamless construction.

A variety of products can be manufactured in accordance with concepts of the invention including single or multi-chambered stainless steel faucet bodies and other water fixtures. A preferable embodiment of the invention provides stainless steel faucet bodies formed with a main body having an internal hollow center cell with a plurality of dividing chambers. The dividing chambers may separately provide or serve as a cold-water inlet, a hot-water inlet and a mixed warm-water outlet that controls or conducts the direction of the warm-water flow. In a preferable embodiment, a main faucet body may be constructed with hollow, under-cut, multi chambers by using one or more high temperature resistance ceramic cores during a lost wax investment casting process. The main faucet body may have under-cut chambers or structures that protrude from the general surfaces (internal or external) of the faucet body and may create overhanging structures. The under-cut or overhanging structures may be about or up to about 5, 10, 20, 30, 50, 60, 70, 80, 90, or 95% of the width, length, or height of the faucet body. Once the ceramic cores are cleaned and removed or moved out of a cast, a single one-piece stainless steel main faucet body is thus provided, and completed without additional operation. No additional time-consuming manufacturing steps are required such as parts welding, screw assembly or precision press fitting to form the final seamless stainless steel faucet body. It shall be understood however that additional components may be combined with any of the single piece bodies described herein to provide a complete water faucet such as handles, lift rods, and aerators.

Another aspect of the invention provides stainless steel faucets and water fixtures that are substantially lead-free, non-verdigris, and non-toxic. Such products may be manufactured to comply with EPA regulations and imposed lead/toxic limits, while also saving manufacturing costs by eliminating additional welding or machining expenses. Other aspects of the invention also combine the use of CIM processes and core assemblies with investment casting techniques to produce a variety of products, including single body construction stainless water fixtures and components such as faucet bodies. Different types of starting materials can be used including less hazardous metals preferably such as stainless steel.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a sectional view of a one piece stainless steel faucet body with multi-hollow center-chambers manufactured in accordance with an aspect of the invention.

FIG. 2 is a sectional view of a first half-open wax pattern for a faucet body of which the half-open chambers cavities are ready for the set-in of one or more ceramic cores.

FIG. 3 is a ceramic core assembly consisting of one or more individual ceramic core units, and further illustrated in the following exploded views: FIG. 3C is a cross-sectional view of the core assembly; FIG. 3T is a top view of the core assembly; and FIG. 3S is a side view of the core assembly.

FIG. 4 is a cross sectional view of a core assembly laid into one or more cavities of a half-open wax pattern (see FIG. 2). FIG. 4A illustrates a core assembly that is ready for placement onto or into a half-open wax pattern. FIG. 4B illustrates a whole core assembly positioned onto or into a half-open wax pattern. FIG. 4C is a cross sectional view of a completed wax pattern around ceramic cores and a protruded portion.

FIG. 5 is a perspective view of a finished wax pattern. FIG. 5A is a cutaway view illustrating a faucet body with a protruded portion of the ceramic core which can act as a binding bridge to connect an outer shell during a slurry dipping process.

FIG. 6B is a top view of a preferable design for a two cavities (6B-1 and 6B-2) wax injection bottom die. FIG. 6T illustrates a preferable design for two cavities (6T-1 and 6T-2) wax injection upper die.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

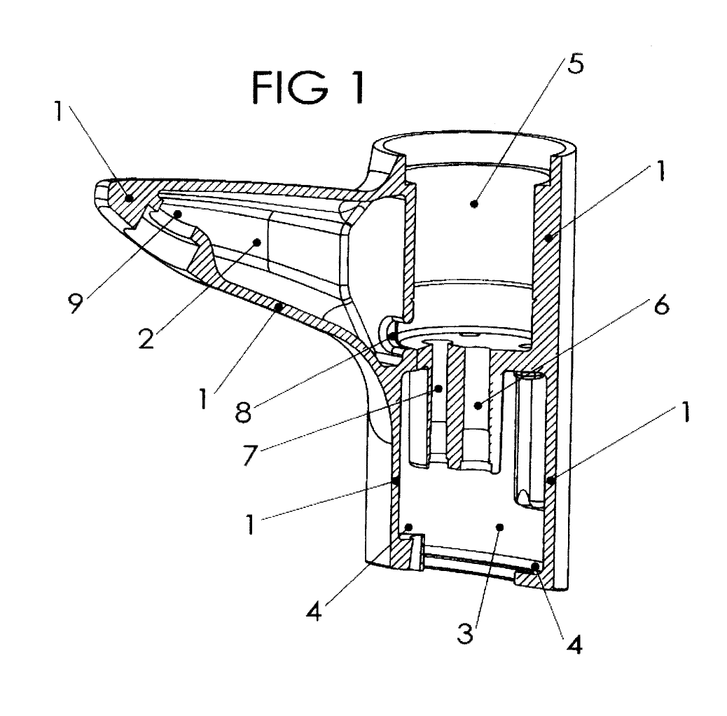

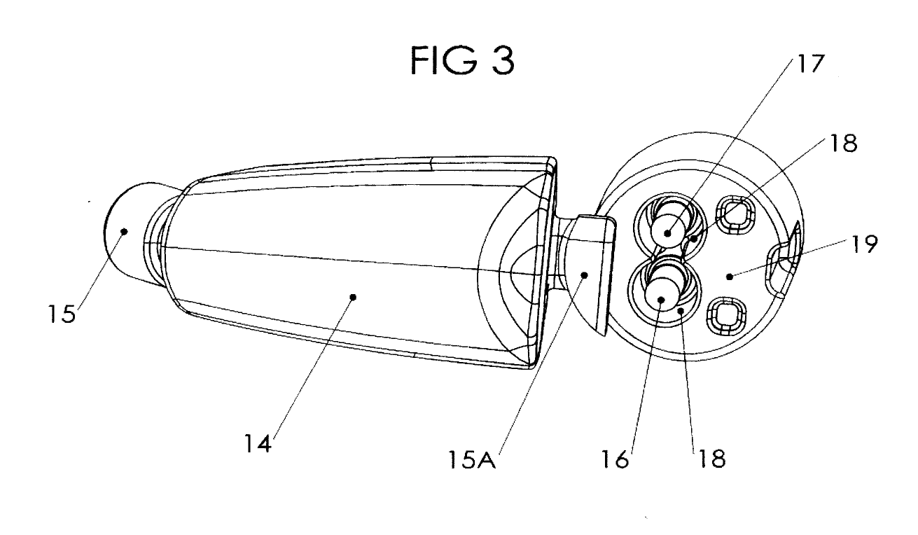

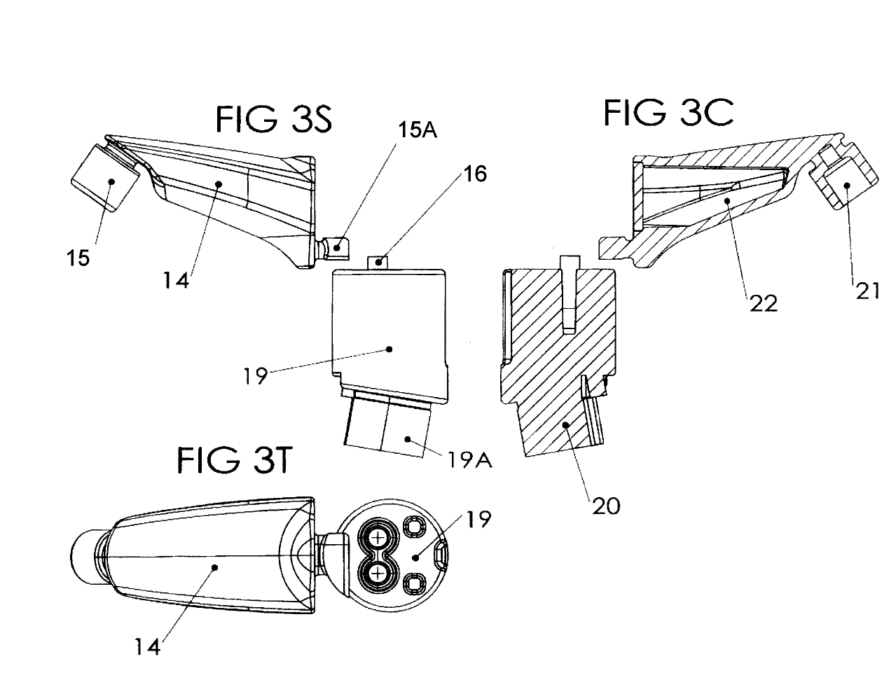

FIG. 1 illustrates a stainless steel faucet body that can be made in accordance with the invention. In some embodiments, a faucet may have a main body 1 that is a seamless one-body stainless steel faucet. The one-body faucet can be integrally formed, formed within a single processing step, formed without forging, or formed without milling. The body can be formed by investment lost-wax or lost-foam casting. Formation by investment casting can have a number of advantages. For example, investment casting can allow the main body to be formed from a wide array of metals and metal alloys, including stainless steel, brass, and others. In some embodiments, metals and metal alloys that are low in lead content, e.g., about, less than about or up to about 3, 2, 1, 0.25, 0.2, 0.1, 0.05, 0.01, 0.005, 0.001, or 0.0001% lead can be used to form the body. The body can be formed of other metals alternatively and can be constructed with multiple internal chambers, of which a plurality of under-cut hollow center cavities 2 and 3 are formed respectively by one or more ceramic cores (see 14 and 19 as indicated in FIG. 3). The formation of a central cavity 5 as shown in FIG. 1 can be achieved by using a metal core pin with a hydraulic pulling device. A corner 4 shown in FIG. 1 can be formed with an under-cut design that can be formed preferably by using a ceramic core provided in accordance with other aspects of the invention (see 19 as indicated in FIG. 3). A through cold water inlet passageway 6 and a hot water inlet passageway 7 as shown in FIG. 1 can be also formed respectively with ceramic core pins (see 16 and 17 as indicated in FIG. 3). In addition, a warm water outlet 9 and a warm water through passage 8 can be by formed with additional ceramic cores in accordance with other aspects of the invention (see 15 and 15A as indicated in FIG. 3). The hot water inlet and cold water inlet can be connected to external fluid sources. Fluid from the a hot water inlet and a cold water inlet can be mixed within an internal chamber of the faucet body and then exit the faucet through a warm water through passage and spout. The amount and ratio of hot and cold water allowed to pass through the faucet can be controlled by valves, which may or may not be automatic or automated by sensors, or any other mechanisms. As indicated in the cross-sectional view of FIG. 1, a one-body construction of the stainless steel main body is fully illustrated that can be manufactured preferably by the combined use of a lost wax investment casting process and a combination of high temperature resistance ceramic cores.

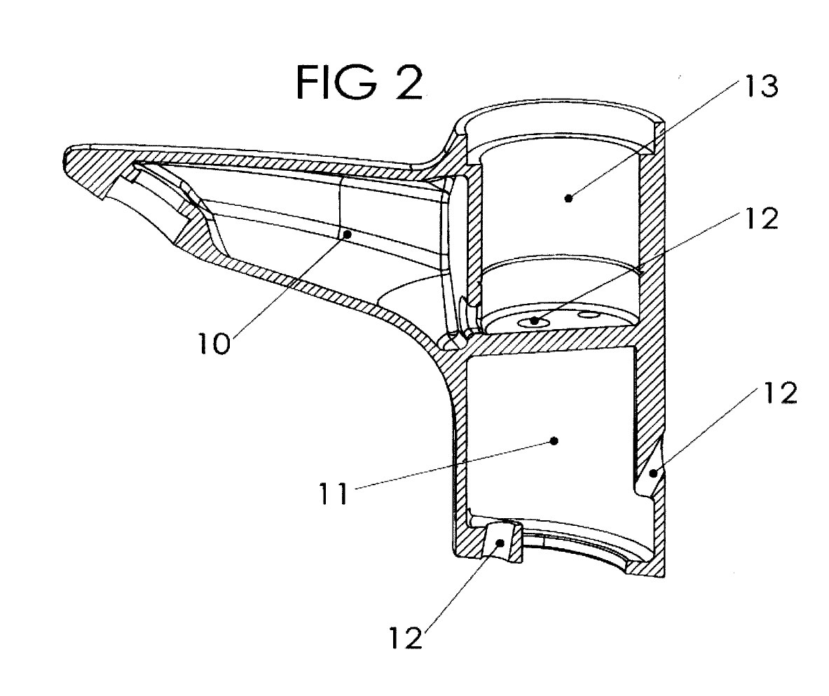

Referring now to a half-open wax pattern as illustrated in FIG. 2, a spout cavity 10 and a base cavity 11 may be formed by a pair of bottom/top pair of die cavities (see bottom die cavity 6B-1 and upper die cavity of 6T-1) during a wax injection process. The spout cavity 10 of the half-open wax pattern can match the shape and configuration of a ceramic spout core (see 14 of FIG. 3), and the base cavity 11 of the half-open wax pattern can match the shape and configuration of a ceramic base core (see 19 of FIG. 3). A group of up to three or more through holes 12 as shown in FIG. 2 can be respectively formed by one or more metal core pins with hydraulic pullers during the wax injection process using known techniques. Central cavity 5 may also be formed using a variety of techniques, for example the cavity may be formed using a ceramic core pins, a metal core pin, or any other technique.

The spout cavity 10 and the base cavity 11 formed from the half-open wax pattern allow the inset of their corresponding ceramic cores after they are de-molded from a first wax injection die cavity (see 6B-1 and 6T-1). The first half-open wax pattern after de-molding may then be placed into and onto a second die cavity (see 6B-2 and 6T-2). The ceramic cores may be thus put into and onto to cavities of the first bottom half-open wax pattern, ready for a subsequent wax injection process to form the second upper half wax pattern, and to overall wrap the ceramic cores inside the finish wax pattern. In the mean time, a semi-melted upper half-open wax pattern can be melted and bonded tightly to the lower half-open wax pattern during the wax injection process. A fully finished one-body construction of wax pattern is thus completed and formed from the combined two half wax patterns.

Another aspect of the invention provides ceramic core assemblies for investment casting that are formed from one or more combined core portions. A ceramic core or CIM core assembly may be combined or bridged with an outer ceramic shell to form complete ceramic molds for fixtures and other end products described elsewhere herein. For example, a ceramic core assembly as illustrated in FIGS. 3, 3S, 3C and 3T may consist of a spout core unit 14 and base core unit 19, and each may be formed of ceramic material. The spout core unit 14 may be also formed with a nozzle protrusion 15, which may act as a bonding bridge during a preferable slurry dipping and coating process later while building up the multi-layers to an outer (ceramic) shell. FIG. 3C also shows the spout core unit walls 22 and the nozzle protrusion walls 21. Warm water through passage 15A is also depicted. In addition, a neck protrusion 19A as part of the base core unit 19 may similarly function as another bonding bridge. A pair of post core protrusions 16 and 17 may be also formed as part of the base core unit 19 as shown in FIG. 3. The post core protrusions 16 and 17 may act as bonding bridges as well to the shell which are formed during the slurry dipping and zircon (or zirconium silicate) coating process that builds-up the outer layers. The post core protrusions 16 and 17 may be positioned within wells 18. The wells can form connection points to the hot and cold water sources. In some embodiments, the connection points can be threaded to facilitate connectivity. The cores described herein may or may not be hollow. Hollow cores can facilitate later removal of the core by increasing the available surface area of the core material, and reducing the amount of core material needed. During formation of the shell, the internal hollow surface of the core can be fused to the external shell such that the hollow internal surfaces and spaces of the core are exposed to the external environment.

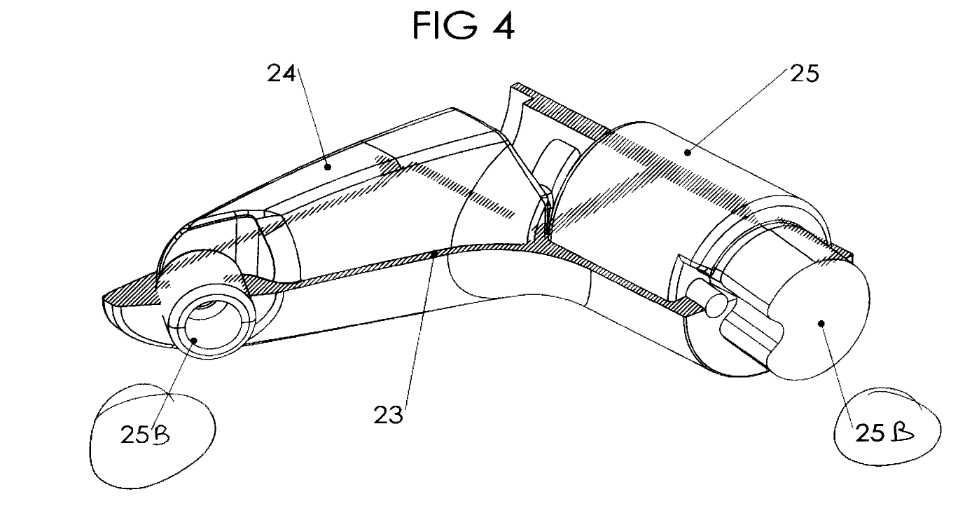

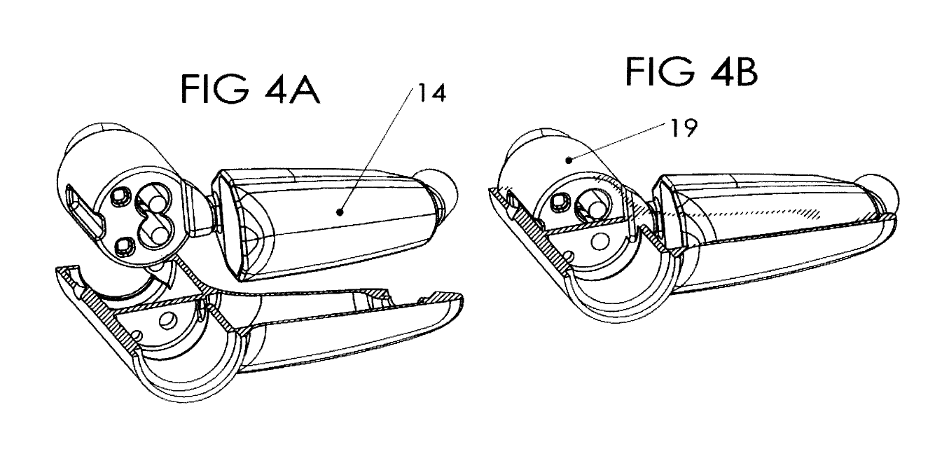

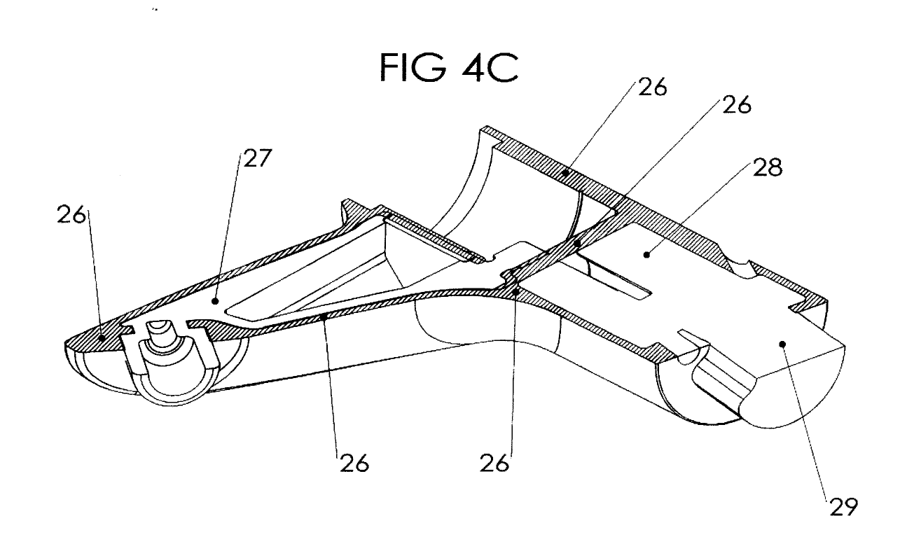

FIG. 4 is a cross sectional view of a core assembly laid into one or more cavities of a half-open wax pattern (see FIG. 2). As shown, the inlay of a ceramic core assembly may be positioned such that the ceramic cores can be fully wrapped inside the finish wax pattern 23. A spout ceramic core 24 and a base ceramic core 25 may be placed in respective cavities formed in the wax pattern 23. Each or either of the ceramic cores may be formed with one or more bridging protrusions 25B which extend beyond the outer surface of the wax pattern in order to bridge the core assembly to an outer ceramic shell that may be formed around the (full) wax pattern during a ceramic dipping process.

As shown in FIG. 4A, a core assembly can be ready for placement onto or into a half-open wax pattern. The spout core portion 14 and the base core portion 19 may be combined to form an entire core assembly before placement into the wax pattern, or alternatively, each individual core portion may be separately positioned.

As shown in FIG. 4B, the whole core assembly is positioned onto or into a half-open wax pattern. The fitting and setting of the cores may be preferably placed with precision and desired spacing into the half-open wax pattern.

FIG. 4C illustrates a sectional view of a fully completed wax pattern 26 that is formed or constructed around a plurality of ceramic cores that can make-up a core assembly. A spout core portion 27 and a base core portion 28 can be preferably formed with interior hollow regions as shown. A desired wall thickness may be selected for the core portions in order provide sufficient structural strength yet leaving enough of a void or voids therein, which reduces the amount of core ceramic material needed, and allows for or facilitates their removal as described elsewhere herein. A protruded portion 29 may be formed as part of the base core portion 28 as shown in FIG. 4C. The protruded portion 29 may act as a bonding bridge to the outer shell that can firmly and solidly fix and suspend the ceramic core 28 in or around the center or central portion of the hollow (chamber) ceramic mold. In preferable embodiments, the protruded portion bonds to an outer shell during a casting process, to prevent or minimize any cores from breakage or collapsing during the casting process.

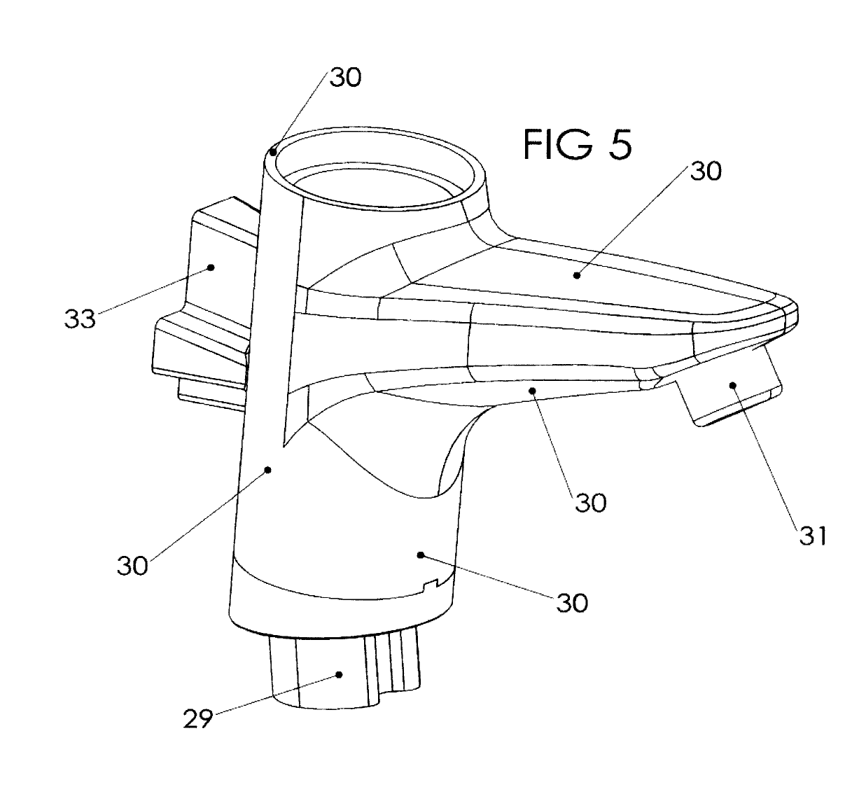

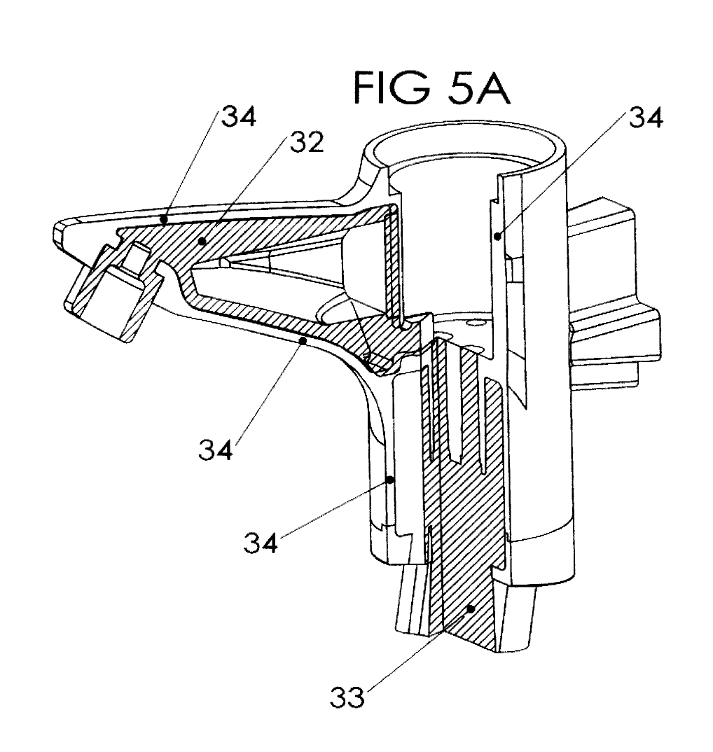

As illustrated in FIG. 5, a fully finished wax pattern of a water faucet or fixture main body 30 can be well constructed and produced from a wax injection die cavity (see 6B-2 and 6T-2) in accordance with the invention. A wax in-gate 33 may be formed as shown in FIG. 5 so that the pattern 30 is ready for treeing (and combining with other patterns into batches). In addition, a base core protruded portion 31 and a nozzle core protruded portion 29 extend away from the wax pattern 30 and are ready for connection or bonding to a formed outer shell. These and other ceramic protrusions from the wax pattern for the faucet body 30 can act as a binding bridge that connects to an outer shell during a slurry dipping process. As described previously, the shell can connect to the core such that the internal hollow spaces of the core are exposed to an external environment. In other embodiments of the invention, the cores are closed cell structures and internal hollow spaces are not exposed to an external environment. Accordingly, the full wax pattern 30 can provide a single or one-body construction main body after slurry dipping, de-waxing and casting.

FIG. 5A shows a cross sectional view of a full wax pattern with core assembly therein (see in FIG. 5). The ceramic cores can be wrapped within and located inside the wax pattern. For example, a hollow spout core 32 (cross hatched) and hollow base core 33 (cross hatched) are enclosed within the full overall wax pattern 34 as illustrated.

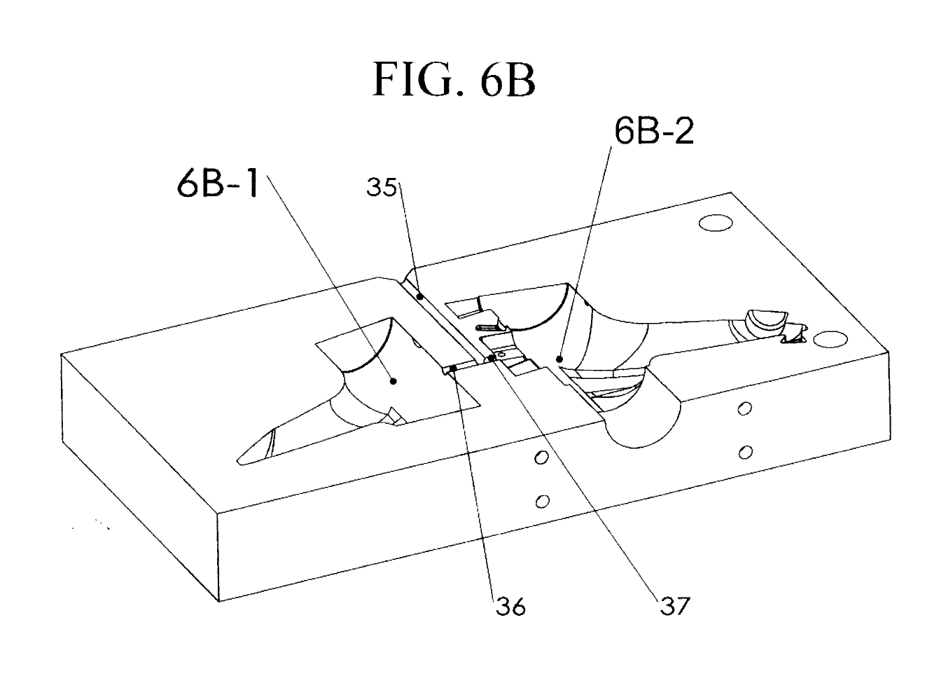

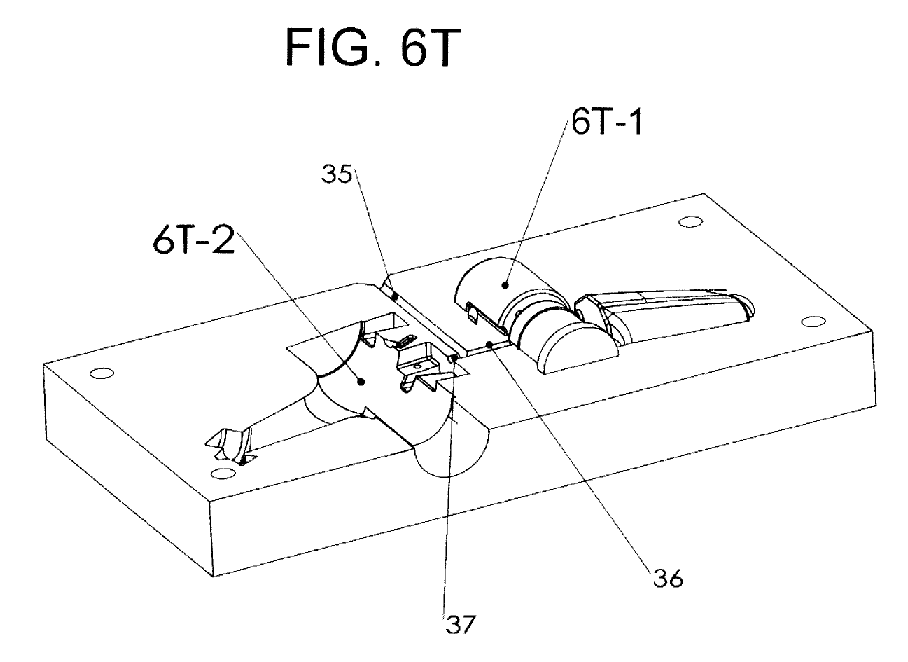

FIGS. 6B and 6T illustrate a set of top/bottom wax injection dies that can be designed with two die cavities as shown. FIG. 6B provides a top view of a wax injection bottom die design that preferably forms two cavities 6B-1 and 6B-2. The two cavities, 6B-1 and 6B-2, show two possible designs for a faucet main body. FIG. 6T provides a top view of a wax injection upper die design that preferably forms two cavities 6T-1 and 6T-2. Cavity 6T-1 shows a wax injection mold positioned with the cavity. The wax injection upper die may be designed with the two die cavities shown FIG. 6T or other selected shapes. The upper die can match precisely with the bottom die (mirror images), and in preferable embodiments, provide symmetrical single piece or unitary metal products.

Furthermore, as shown in FIGS. 6B and 6T, a main injection gate and runner 35 may be formed in the dies as shown which maybe split into two sub-runners 36 and 37 to guide a wax flow respectively into die cavity 6B-1/6B-2 and 6T-1/6T-2, respectively. The wax flow may be introduced to fill up the first half-open wax pattern and the second finished wax pattern in a one single step or operation of wax injection. Alternatively, the wax pattern injection process can also be done by two separate injection machines to respectively complete the half-open wax pattern and fully complete wax pattern within the scope of this invention. It shall be understood that any of the fixtures and faucet components described herein can be formed using the aforementioned wax injection dies and processes.

Ceramic Mold—Cores and Shell

Many aspects of the invention can incorporate current investment casting techniques with the addition of certain modifications and manufacturing choices provided herein. For example, in an exemplary process, a ceramic mold can be prepared starting with one, two (dual core) or more coated ceramic cores. In some preferable embodiments, the CIM cores may be coated with a sealant material that is water impermeable or substantially water impermeable as known by those of ordinary skill in the art. The selected material may vary according to particular formulations of the core to provide in some instances a waterproof or water resistant coating. The sealant can be a resin and/or exposy material. In some embodiments, the material can respond in a desired manner to KOH. Preferably, the ceramic or CIM cores provided herein are formed with internal cavities or voids, each having a shape generally corresponding to a part or portion (for a faucet body) of the product to be cast. The core assemblies may be substantially enclosed within a full wax pattern, wherein protrusions extend therefrom to serve as bridges and connecting points. A tree or cluster of molds may be prepared in batches by connecting a series of the one or more full wax patterns. The patterns may be preferably formed by molding wax over ceramic core assemblies described elsewhere herein that generally correspond to the “positives” of the interior regions of the parts to be cast. Next, in a shelling process, a ceramic shell can be formed around one or more such patterns in well known fashion such as dipping in zircon. The wax may be removed thereafter such as by melting in an autoclave. The shell may be then fired to harden the shell. Accordingly, a series of one or more molds are provided wherein each comprises a shell having one or more part-defining compartments which contain therein an assembly of spaced apart ceramic core(s) provided in accordance with the invention to define the interior passages and chambers of a part such as a water fixture or faucet body.

The ceramic shell (also “shell” herein) can be formed of refractory materials, such as silica, zircon, various aluminium silicates, and alumina. Silica can be usually used in the fused silica form, but sometimes quartz can be used. Other refractory materials that can be used include molochite and chamotte.

Following formation of the mold(s), molten alloy or metal such as stainless steel may be introduced to cast the part(s). Upon cooling and solidifying of the alloy or metal, the shell and core assembly may be mechanically and chemically removed from the molded part(s) as described elsewhere herein. The part(s) can then be further assembled, plated, machined and/or treated in one or more additional stages.

Ceramic Cores—Design and Shape

The ceramic or CIM core assemblies provided in accordance with the invention may be formed with a variety shapes and figures corresponding to the interior region of a part such as a water fixture or faucet body. Depending on the complexity of the interior region, an assembly may be formed of one or more ceramic core portions that maybe assembled together within a half and/or full wax pattern described herein. In preferable embodiments, the ceramic cores are formed with hollow regions or voids that provide numerous advantages in accordance with another aspect of the invention.

For example, once a shell is removed from a ceramic mold, post-processing of the ceramic cores may be performed. A preferable post-processing step includes soaking or bathing the entire cast product with the ceramic cores in an alkali salt solution. A variety of solutions may be selected depending on the type of ceramic core material that is used. In preferable embodiments, potassium hydroxide (KOH) may be used which dissolves or core material residing within the cast product. In some embodiments of the invention, the core material can be dissolved away in a matter of one or two days (24-48 hours), or even up to several days. However in a preferable embodiment, the ceramic cores can be dissolved away in approximately 10-20 minutes. The internally situated ceramic cores can be rapidly dissolved and removed from a cast product by mechanically designing the ceramic cores with one or more hollow regions or voids. By exposing a solution or solvent to the interior surface of the ceramic core, a significantly greater surface area is provided which allows the solvent to react and dissolve the ceramic core(s). When the solution penetrates the inner cavity of a core, there becomes in effective almost double (2×) the surface area for the solution to attack. Moreover, there is less material for the solution to penetrate which can be measured by the thickness of the walls of the ceramic cores. The cores can be preformed with holes or openings to allow the passage of solution therein, or the solution can be allowed to dissolve through core walls without assistance. The agitation of the solution may also aid in removing ceramic cores.

Ceramic Materials

A variety of ceramics may be selected for use in accordance with various aspects of the invention. For example, zircon, silica, or a combination of zircon and silica may be used in the dipping process to form an outer shell of ceramic mold. In preferable embodiments of the invention, ceramic core portions and assemblies are formed from a ceramic material that is can be removed in a bath process.

In a preferable embodiment of the invention, the ceramic core assembly and shell are formed of different ceramic materials. For example, the ceramic core and its components can be formed of Ceramic A, while the ceramic core assembly/full wax pattern combination may be dipped or otherwise covered with a Ceramic B. In some applications, it may be preferable to select ceramics with different durability or hardness (wherein Ceramic A is less than Ceramic B) and drying times and high temperature tolerance (wherein Ceramic B is greater than Ceramic A). In accordance with this aspect of the invention, a particular ceramic (core ceramic) may be selected to form the one or more cores that eventually become fixed within interior portions of a water faucet body or fixture. The core ceramic, preferably a semi-organic ceramic material, such as, e.g., fine sized power of fused alumino silicate (Alₓ(SiO₂)_{y}, such as, e.g., Al₂SiO₅) and calcine zircon silicate (e.g., ZrSiO₄) between about 6 to 8 hours to combine, may exhibit different properties than a shell ceramic, in order to withstand the mechanical forces experienced during removal of the external ceramic shell, yet soluble in a selected solution (alkali salt solution) in order to remove the cores from interior portions of cast products. Any of the ceramic materials selected however should withstand the temperatures experienced during zircon dipping, pouring and casting with stainless steel (melting point in excess of 1475 C) and other high temperature metals, or other steps in the processes described herein.

Plating

In accordance with another preferable embodiment of the invention, the water fixtures and faucet bodies provided herein can be finished by performing additional processes, such as electroplating and/or electro-less chemical plating. The exterior (or external) surfaces can be electroplated with nickel, hard chrome, or a combination of the two. For example, the exterior or interior surfaces of the faucet bodies provided herein can be plated with rust resistant metals such as nickel (Ni). In particular, because the interior surfaces of prior water faucets formed from known techniques were too porous or rough, the single unitary faucet bodies provided herein include smooth surfaces that are more favorable to industrial metal finishing and can be plated to seal and protect their interior passageways or inner walls. This can be attributed at least in part to the smooth outer surfaces of the CIM core assemblies herein. For certain preferable embodiments, a coating or plating of nickel can be deposited having up to five microns thickness.

The principles of the invention provided herein may be applied to various aspects of known ceramic core applications and investment casting techniques such as those processes and systems described in U.S. Pat. Nos. 4,569,384, 5,387,280, 5,779,809 and 6,505,678, which are all incorporated by reference herein in their entirety.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A water faucet component comprising:
a seamless one-body construction stainless steel faucet main body with one or more hollow internal chambers thereby forming at least a cold water inlet, a hot water inlet, and a warm water outlet for directional control of water flow.

2. A ceramic core assembly for investment casting comprising:
a plurality of ceramic cores spatially arranged with respect to each other for one or more wax injection processes to form a one-body construction wax pattern of a product with a hollow center region and multiple internal chambers.

3. The ceramic core assembly of claim 2, further comprising additional full wax patterns to form a pattern tree assembly for slurry dipping and coating to build-up an outer shell, and at least one of the following: lost wax, shell sintering, and melt stainless steel pouring.

4. The ceramic core assembly of claim 3, further comprising a hollow one-body construction stainless steel faucet body, and wherein the body includes an interior region that substantially surrounds the plurality of ceramic cores positioned internally therein.

5. A full wax pattern and core assembly comprising:
a first half and a second half-open wax pattern joined together to form the finished wax pattern with a core assembly pre-set into a plurality of cavities formed the first and the second half-open wax pattern.

6. A ceramic core assembly for a water fixture comprising:
a plurality of high temperature resistance ceramic cores configured to the internal region of the water fixture for an investment casting process to produce a one-body construction stainless steel faucet main body with a hollow center region and multiple chambers for water flow.
